(19) United States
(12) Patent Application Publication
(10) Pub. No.: US 2024/0138536 A1
(43) Pub. Date: May 2, 2024

(54) EYEWEAR STORAGE DEVICE

(71) Applicant: Patricia Susan Hovey, Rockaway, NJ (US)

(72) Inventor: Patricia Susan Hovey, Rockaway, NJ (US)

(21) Appl. No.: 17/979,080

(22) Filed: Nov. 2, 2022

(51) Int. Cl. A45C 11/04; A45C 13/00

(52) U.S. Cl. CPC A45C 11/04; A45C 13/005; A45C 2011/002

(57) ABSTRACT

An eyewear storage device may include a base plate, having a rear surface and an opposing front surface, a receiver plate having a plate interior surface; a first receiver wall coupled to the receiver plate, the first receiver wall having a first wall interior surface, and a second receiver wall coupled the receiver plate, the second receiver wall having a second wall interior surface. The first and second wall interior surfaces may extend away from the plate interior surface so that the first and second wall interior surfaces generally face each other. The first receiver wall may be movably coupled to the base plate so that the receiver plate is movable between a first position and a second position. A cavity may be formed between the rear surface, plate interior surface, first wall interior surface, and second wall interior surface when the receiver plate is in the first position.

### FIELD OF THE INVENTION

This patent specification relates to the field of devices configured to receive eyewear, such as vision correcting eyeglasses. More specifically, this patent specification relates to a device configured to store eyewear and to secure the eyewear to other objects.

### BACKGROUND

Eyewear, such as vision correcting eyeglasses, sunglasses, safety glasses, etc., are used by many people for vision correcting purposes and for one or more specific activities, such as for reading and operating electronic devices, such as smartphones, computers, and the like. Unfortunately, it is very common for people to lose and misplace their eyewear. It is another all too common occurrence for people to intentionally leave their eyewear behind because they do not foresee a safe and reliable way to bring their eyewear when traveling. For these reasons, many people that need or could benefit from eyewear must make do without.

Therefore, a need exists for novel devices configured to store eyewear, such as vision correcting eyeglasses, sunglasses, safety glasses, etc. A further need exists for novel devices for storing eyewear that are able to prevent users from losing and misplacing their eyewear. There is also a need for novel devices for storing eyewear that are able to provide a safe and reliable way to bring eyewear when the user is traveling.

### BRIEF SUMMARY OF THE INVENTION

An eyewear storage device is provided which is configured to receive objects, such as eyewear and glasses, and to be coupled to electronic devices, such as smartphones. In some embodiments, the device may include a base plate, a receiver plate, a first receiver wall, and a second receiver wall. The base plate may have a rear surface and an opposing front surface. The receiver plate may have a plate interior surface. The first receiver wall may be coupled to the receiver plate, and the first receiver wall may have a first wall interior surface. The second receiver wall may also be coupled to the receiver plate, and the second receiver wall may have a second wall interior surface. The first wall interior surface and the second wall interior surface may extend away from the plate interior surface so that the first wall interior surface and the second wall interior surface may generally face each other. The first receiver wall may be movably coupled to the base plate so that the receiver plate is movable between a first position and a second position. A cavity may be formed between the rear surface, plate interior surface, first wall interior surface, and second wall interior surface when the receiver plate is in the first position. Preferably, an article of eyewear may be received in the cavity and an electronic device may be coupled to the front surface of the base plate.

In further embodiments, the device may include a bottom plate and a support arm that may both be coupled to the base plate, and the support arm and bottom plate may be configured to rest on a supporting surface to support the device in an upright position, thereby allowing the device to function as a stand for an electronic device coupled to the base plate.

In further embodiments, the device may include a first gripping assembly which may be coupled to the base plate and which may extend above the front surface and a second gripping assembly that may also be coupled to the base plate and may extend above the front surface.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a rear perspective view of an example of an eyewear storage device in a closed position according to various embodiments described herein.

FIG. 2 illustrates a front perspective view of an example of an eyewear storage device in a closed position according to various embodiments described herein.

FIG. 3 shows a first side elevation view of an example of an eyewear storage device in a closed position according to various embodiments described herein.

FIG. 4 depicts a rear perspective view of an example of an eyewear storage device in an open position according to various embodiments described herein.

FIG. 5 illustrates a perspective exploded view of an example of an eyewear storage device according to various embodiments described herein.

FIG. 6 shows a second side elevation view of an example of an eyewear storage device in an upright position and having an electronic device coupled to its base plate according to various embodiments described herein.

FIG. 7 depicts a front perspective view of an example of an eyewear storage device having an electronic device coupled to its base plate according to various embodiments described herein.

FIG. 8 illustrates a rear perspective view of an example of an eyewear storage device having an electronic device coupled to its base plate according to various embodiments described herein.

FIG. 9 shows a front perspective view of another example of an eyewear storage device according to various embodiments described herein.

FIG. 10A depicts a side elevation view of another example of an eyewear storage device having a support tab that is in a stowed position according to various embodiments described herein.

FIG. 10B depicts a side elevation view of another example of an eyewear storage device having a support tab that is in an extended position according to various embodiments described herein.

FIG. 11 illustrates a front perspective view of another example of an eyewear storage device having an electronic device coupled to its base plate according to various embodiments described herein.

FIG. 12 shows a rear perspective view of another example of an eyewear storage device having an electronic device coupled to its base plate according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

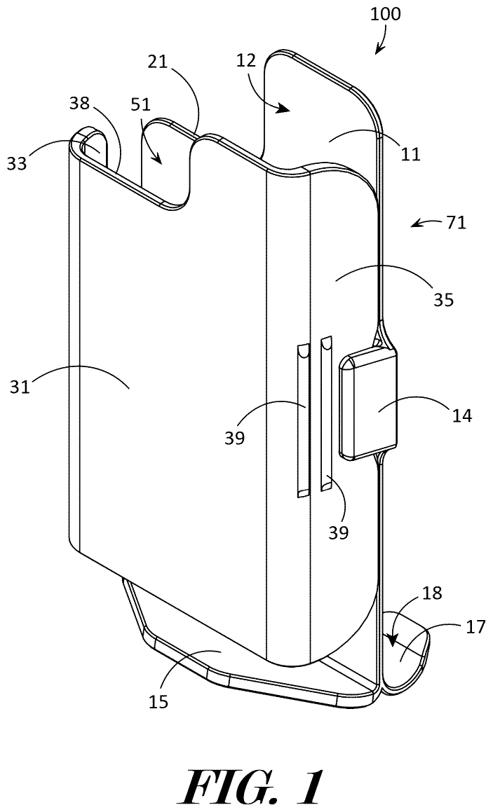

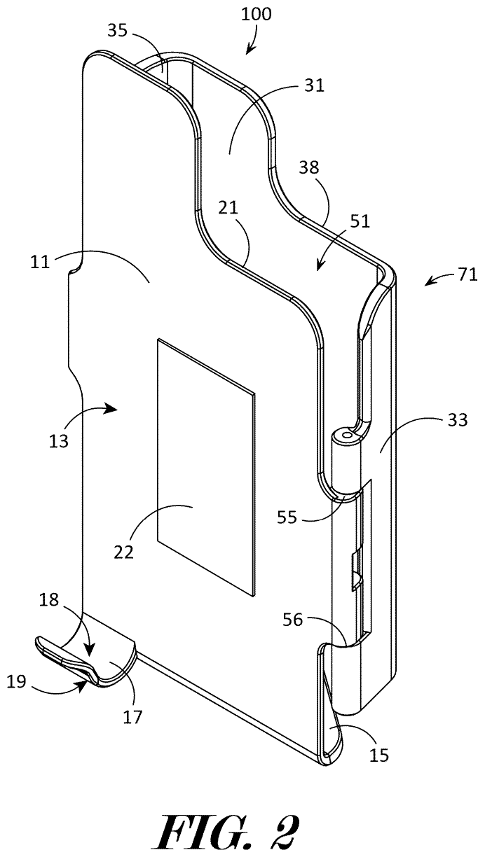

For purposes of description herein, the terms “upper,” “lower,” “left,” “right,” “rear,” “front,” “side,” “vertical,” “horizontal,” and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first,” “second,” etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 15% of the specified number. Additionally, as used in this application, the term “substantially” means that the actual value is within about 10% of the actual desired value, more preferably within about 5% of the actual desired value and even more preferably within about 1% of the actual desired value of any variable, element or limit set forth herein.

A new eyewear storage device is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

The present invention will now be described by example and through referencing the appended figures representing preferred and alternative embodiments. FIG. 1 illustrates an example of an eyewear storage device (“the device”) 100 according to various embodiments. In some embodiments, the device 100 may comprise a base plate 11 having a rear surface 12 and an opposing front surface 13, a receiver plate 31 having a plate interior surface 32, a first receiver wall 33 coupled to the receiver plate 31, the first receiver wall 33 having a first wall interior surface 34, and a second receiver wall 35 coupled the receiver plate 31, the second receiver wall 35 having a second wall interior surface 36. The first wall interior surface 34 and the second wall interior surface extend 36 away from the plate interior surface 32 so that the first wall interior surface 34 and the second wall interior surface 36 face each other. The first receiver wall 33 may be movably coupled to the base plate 11 so that the receiver plate 31 is movable between a first position 71 and a second position 72. A cavity 51 may be formed between the rear surface 12, plate interior surface 32, first wall interior surface 34, and second wall interior surface 36 when the receiver plate 31 is in the first position 71.

The device 100 may comprise a base plate 11 that may be coupled to a receiver plate 31 and another object, such as an electronic device 200 (e.g., smartphone). A base plate 11 may comprise one or more rear surfaces 12 and one or more opposing front surfaces 13. Generally, a rear surface 12 may face the receiver plate 31 when the device 100 is in the first position 71, while a front surface 13 may be positioned on the opposite side of the base 11 and an electronic device 200 or other object may be coupled to the front surface 13.

In some embodiments, a base plate 11 may be generally flat and planar in shape, and may have a generally flat and planar in shape rear surface 12 and a generally flat and planar in shape front surface 13. In further embodiments, a base plate 11 and its one or more rear surfaces 12 and front surfaces 13 may be configured in any size and shape. Preferably, a base plate 11 may be made from or may comprise various types of hard plastics, such as polyethylene (PE), Ultra-high-molecular-weight polyethylene (UHMWPE, UHMW), polypropylene (PP) and polyvinyl chloride (PVC), polycarbonate, nylon, Poly(methyl methacrylate) (PMMA) also known as acrylic, metal or metal alloys, such as aluminum and steel, carbon fiber, wood, bamboo, and other natural materials, or any other material including combinations of materials that are substantially rigid.

The device 100 may comprise a receiver plate 31, a first receiver wall 33, and a second receiver wall 35 that may be coupled to the base plate 11. In preferred embodiments, a receiver plate 31, a first receiver wall 33, and a second receiver wall 35 that may be movably coupled to the base plate 11 so that the receiver plate 31, first receiver wall 33, and second receiver wall 35 may be moved between a first position 71 and a second position 72. In the first position, the receiver plate 31 may be moved relatively closer to the base plate 11, while in the second position 72, the receiver plate 31 may be moved relatively farther from the base plate 11.

In preferred embodiments, a first receiver wall 33 and a second receiver wall 35 may be coupled to opposing ends of the receiver plate 31. The first receiver wall 33 may have a first wall interior surface 34, the second receiver wall 35 may have a second wall interior surface 36, and the receiver plate 31 may have a plate interior surface 32. The first wall interior surface 34 and the second wall interior surface 36 may extend away from the plate interior surface 32 so that the first wall interior surface 34 and the second wall interior surface 36 face each other. Optionally, portions of the first wall interior surface 34 and portions of the second wall interior surface 36 that are distal to the plate interior surface 32 may be approximately parallel to each other.

The device 100 may comprise a cavity 51 that may be formed between the rear surface 12, plate interior surface 32, first wall interior surface 34, and second wall interior surface 36 when the receiver plate 31 is in the first position 71. Generally, a cavity 51 may be configured to receive and secure all or portions of an object, such as glasses and other eyewear, so that all or portions of the object, such as eyewear, may be inserted in the cavity 51. A cavity 51 may be configured in any size and shape. Optionally, the device 100 may comprise a strap, clasp, snap-type fastener, or any other fastener, which may be configured to govern the ability of an object, such as eyewear, to be inserted and/or removed from the cavity 51.

In preferred embodiments, the size and shape of the cavity 51 may be defined by the rear surface 12, plate interior surface 32, first wall interior surface 34, and second wall interior surface 36 when the receiver plate 31 is in the first position 71. In some embodiments, a cavity 51 may be configured with a relatively larger shape by having relatively larger receiver walls 33, 35, and relatively larger wall interior surfaces 34, 36, which may position the plate interior surface 32 relatively farther from the rear surface 12. In further embodiments, a cavity 51 may be configured with a relatively smaller shape by having relatively smaller receiver walls 33, 35, and relatively smaller wall interior surfaces 34, 36, which may position the plate interior surface 32 relatively closer to the rear surface 12.

In some embodiments, a receiver plate 31 may be generally flat and planar in shape, and may have a generally flat and planar in shape plate interior surface 32. In some embodiments, the junction between a receiver wall 33, 35, and the receiver plate 31 may be angular, curved, or coupled together in any other configuration. In further embodiments, a receiver plate 31, receiver walls 33, 35, and their respective interior surfaces 32, 34, 36, may be configured in any size and shape.

In some embodiments, a first receiver wall 33 and/or a second receiver wall 35 may be movably coupled to the base plate 11 so that one or more of the receiver plate 31, first receiver wall 33 and/or a second receiver wall 35 may be moved towards and away from the base plate 11. In preferred embodiments, a first receiver wall 33 may be pivotally coupled to the base plate 11 so that the receiver plate 31 may be pivoted between a first position 71 and a second position 72.

In preferred embodiments, the device 100 may comprise one or more hinges 55, 56, which may be configured to movably couple a first receiver wall 33 to the base plate 11 so that the receiver plate 31 may be pivoted between a first position 71 and a second position 72. A hinge 55, 56, may comprise a butt hinge, barrel hinge, butt/Mortise hinge, case hinge, flag hinge, strap hinge, H hinge, HL hinge, piano hinge, butterfly hinge, flush hinge, concealed hinge, continuous hinge, T-hinge, double-acting hinge, Soss hinge, counterflap hinge, flush hinge, coach hinge, rising butt hinge, double action spring hinge, tee hinge, friction hinge, security hinge, cranked hinge or stormproof hinge, lift-off hinge, self-closing or self-positioning hinge, flexible material hinge, living hinge, or any other type or style of hinge suitable for pivotally joining a receiver wall 33, 35, to the base plate 11.

In some embodiments, a receiver wall 33, 35, may be removably coupled to the base plate 11 in order to govern the ability of the device 100 to be moved out of the first position 71. For example, a receiver wall 33, 35, may be removably coupled to the base plate 11 so that user interaction may be required in order to move the device 100 out of the first position 71, such as to open the receiver plate 31 and move it away from the base plate 11. In preferred embodiments, a second receiver wall 35 may be removably coupled to the base plate 11 and a first receiver wall 33 may be movably coupled to the base plate 11.

In preferred embodiments, the device 100 may comprise a retainer lip 37 and a retainer 14 which may be configured to removably couple a receiver wall 33, 35, and more preferably a second receiver wall 35, to the base plate 11. Generally, a retainer lip 37 may comprise a projection or a depression and a retainer 14 may comprise a catching projection or depression that a retainer 14 may engage with to couple the retainer lip 37 and retainer 14, while lifting or forcing the retainer lip 37 and retainer 14 apart may disengage the retainer lip 37 and retainer 14, thereby allowing their separation. A retainer 14 preferably may be movably or flexibly coupled to a base plate 11 (or receiver wall 33, 35), such as via a living hinge or being made of a flexible material, via a spring tensioned arrangement, etc., so that user effort is preferably required and enable to removably engage or removably couple a retainer lip 37 and retainer 14. In further embodiments, a retainer lip 37 and retainer 14 may be removably connected or coupled by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function.

In some embodiments, the device 100 may comprise a bottom plate 15 that may be coupled to a base plate 11 and/or a receiver plate 31. In preferred embodiments, a bottom plate 15 may be coupled to a base plate 11, and the bottom plate 15 may extend towards the receiver plate 31 when in the first position 71. A bottom plate 15 may be configured in any size and shape. Preferably, the bottom plate 15 may comprise a bottom plate support surface 16 which may be sized and shaped to support the device 100 in an upright position 73 on a supporting surface 300 (e.g., table top, desk top, counter top, etc.) to allow the device 100 to function as a phone or electronic device stand for an electronic device 200 that may be coupled to the front surface 13 of the base plate 11. Preferably, a bottom plate support surface 16 may be generally planar in shape. Optionally, a bottom plate 15 may comprise two or more bottom plate support surfaces 16 which may be sized and shaped to support the device 100 in an upright position 73 on a supporting surface 300.

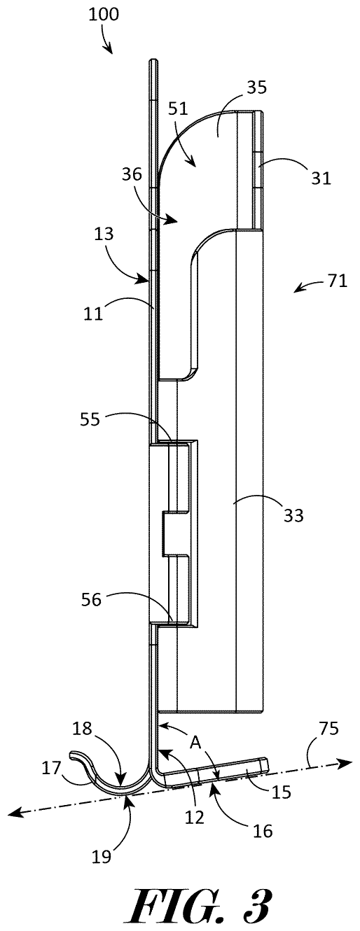

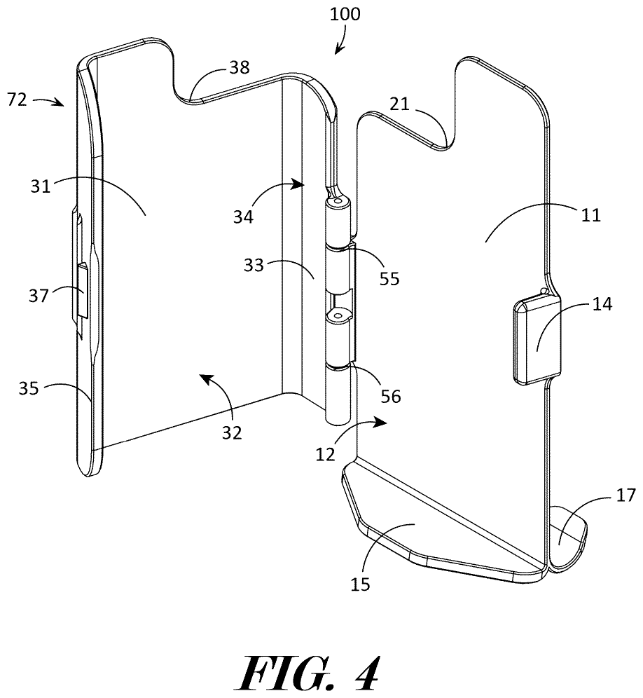

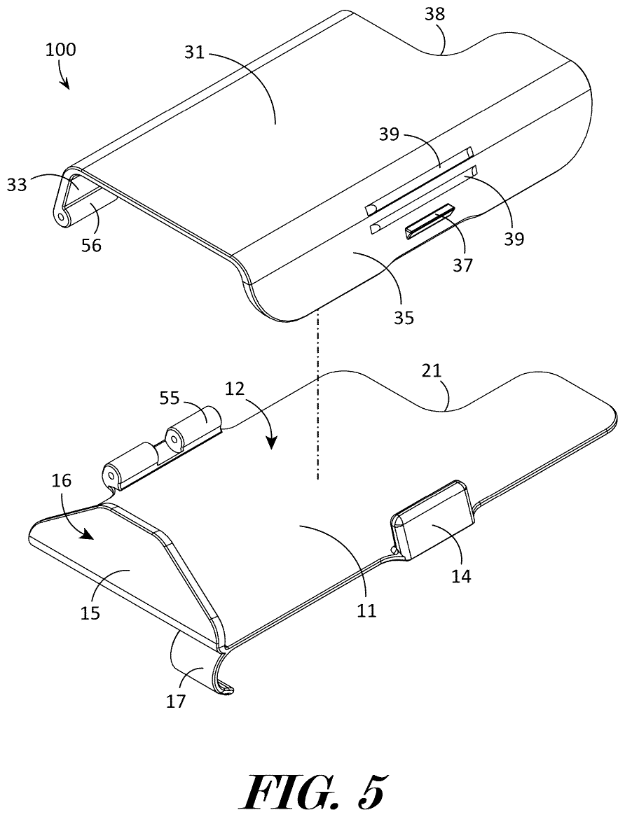

In some embodiments, a bottom plate 15 may comprise one or more bottom plate support surfaces 16 which may be angled towards the rear surface 12 as shown by Angle A in FIG. 3. In preferred embodiments, Angle A may be between 60 and 89 degrees. In further embodiments, Angle A may be approximately 90 degrees. In further embodiments, Angle A may be between 45 and 95 degrees. Preferably, a bottom plate 15 may comprise one or more bottom plate support surfaces 16 which may form or be positioned within a support plane 75 as shown in FIG. 3.

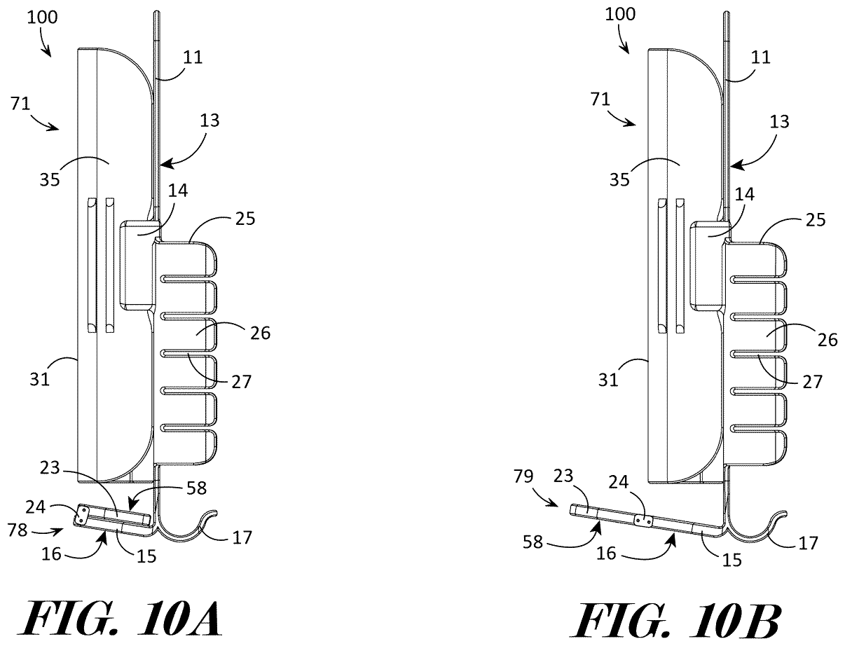

In some embodiments, and as shown in FIGS. 10A and 10B, the device 100 may comprise a support tab 23, having a tab support surface 58, which may be movably coupled to the bottom plate 15. A support tab 23 may be configured in any shape and size. A support tab 23 may be moved between a stowed position 78 and an extended position 79. In the extended position 79, the tab support surface 58 of the support tab 23 may generally function to extend the bottom plate support surface 16 and functions as an outrigger to aid the ability of the device 100 to remain in the upright position on a supporting surface 300 when a relatively larger and heavier electronic device 200 is coupled to the base plate 11.

In preferred embodiments, and as shown in FIGS. 10A and 10B, a support tab 23 may be movably coupled to the bottom plate 15 by being pivotally coupled to the bottom plate 15 so that the support tab 23 may be pivoted between the stowed position 78 and extended position 79. A support tab 23 may be pivotally coupled to the bottom plate 15 via any type of hinged coupling 24 which may comprise any type of hinge as described above or with any other suitable pivotal coupling device or method. In further embodiments, a support tab 23 may be movably coupled to the bottom plate 15 by being slidably coupled to the bottom plate 15 so that the support tab 23 may be slid between the stowed position 78 and extended position 79. A support tab 23 may be slidably coupled to the bottom plate 15 via a tongue and groove connection method or with any other suitable sliding or slidable coupling device or method.

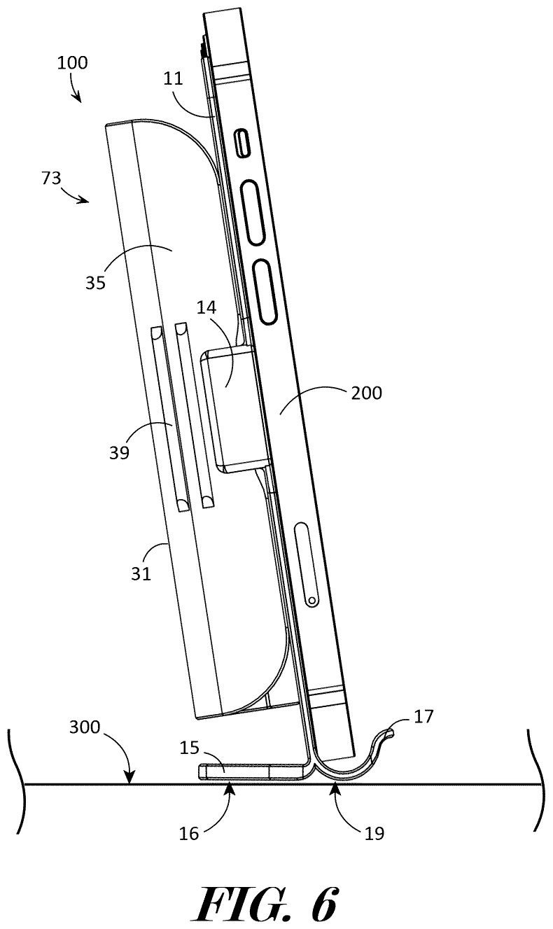

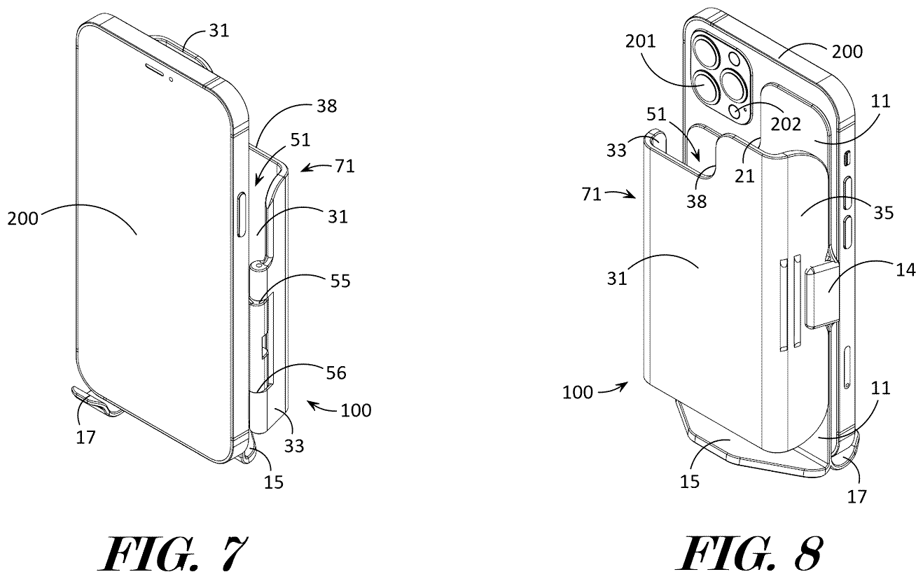

In some embodiments, the device 100 may comprise a support arm 17 that may be coupled to a base plate 11 and/or a receiver plate 31. In preferred embodiments, a support arm 17 may be coupled to a base plate 11, and the support arm 17 may generally extend away from the front surface 13 of the base plate 11 and a bottom plate 15 that may be coupled to the base plate 11. A support arm 17 may be configured in any shape and size. In some embodiments, a support arm 17 may comprise an arm upper surface 18 and an arm lower surface 19 in which the arm upper surface 18 and arm lower surface 19 may be positioned on opposing sides of the support arm 17. Preferably, an arm upper surface 18 may be concave curved in shape and may extend away from the bottom of the front surface 13 so as to provide a device surface which may contact a lower portion of an electronic device 200 that may be coupled to the base plate 11. Preferably, an arm lower surface 19 may be convex curved in shape and configured to contact a supporting surface 300 that a bottom plate support surface 16 is configured to contact such that all or portions of the bottom plate support surface 16 may be in the same support plane 75 as at least a portion of the arm lower surface 19 as shown in FIG. 3. A support plane 75 may comprise one or more surfaces of the device 100 that may be arranged in a planar orientation so as to enable the device 100 to rest on a supporting surface 300 to support the device 100 in an upright position 73 relative to the supporting surface 300 as shown in FIG. 6.

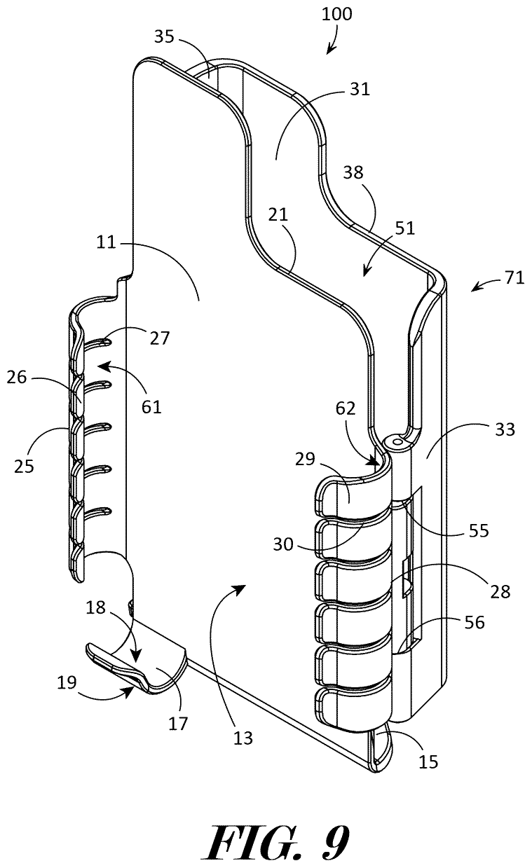

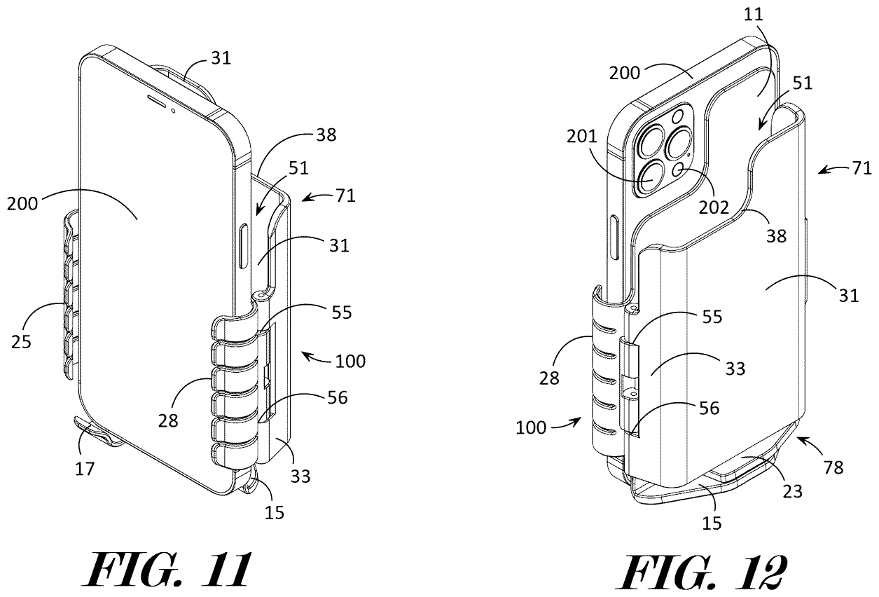

In some embodiments, and as shown in FIGS. 9-12, the device 100 may comprise one or more gripping assemblies 25, 28, that may be coupled to a base plate 11 and/or a receiver plate 31 and that may be configured to couple or otherwise secure an electronic device 200 to the front surface 13 of the base plate 11. In preferred embodiments, the device 100 may comprise a first gripping assembly 25 that may be coupled to the base plate 11 and that may extend above the front surface 13, and the device 100 may comprise a second gripping assembly 28 that may also be coupled to the base plate 11 and that may extend above the front surface 13. Generally, gripping assemblies 25, 28, may be positioned on opposing sides of the front surface 13 of the base plate 11 so that the right and left sides of an electronic device 200 may be positioned between gripping assemblies 25, 28, and the gripping assemblies 25, 28, may grip the right and left sides of an electronic device 200 to engage or couple the electronic device 200 against the front surface 13, preferably without the use of an adhesive fastener 22.

A first gripping assembly 25 may be configured in any shape and size. In some embodiments, a first gripping assembly 25 may comprise one or more, such as a plurality of first gripping projections 26 with each first gripping projection 26 separated from an adjacent first gripping projection 26 via a first channel 27. Similarly, a second gripping assembly 28 may be configured in any shape and size. In some embodiments, a second gripping assembly 28 may comprise one or more, such as a plurality of second gripping projections 29 with each second gripping projection 29 separated from an adjacent second gripping projection 29 via a second channel 30. Preferably, one or more gripping projections 26, 29, may be made of or may comprise a flexible material which may enable the one or more gripping projections 26, 29, to flex and grip the right and left sides of an electronic device 200 so that the electronic device 200 may be tensioned between the gripping projections 26, 29, of the gripping assemblies 25, 28.

Gripping projections 26, 29, may be configured in any size and shape. In preferred embodiments, one or more first gripping projections 26 may comprise a generally convex curved shape first gripping projection proximate surface 61, with each first gripping projection proximate surface 61 being convex curved relative to the side of the electronic device 200 that it is configured to be positioned proximate to so that the one or more first gripping projections 26 may generally wrap around a side of the electronic device 200 and extend over the front of the electronic device 200 in order to prevent the electronic device 200 from falling or moving away from the front surface 13. Likewise and in preferred embodiments, one or more second gripping projections 29 may comprise a generally convex curved shape second gripping projection proximate surface 62, with each second gripping projection proximate surface 62 being convex curved relative to the side of the electronic device 200 that it is configured to be positioned proximate to so that the one or more second gripping projections 29 may generally wrap around a side of the electronic device 200 opposite to that of the first gripping projections 26 and extend over the front of the electronic device 200 in order to prevent the electronic device 200 from falling or moving away from the front surface 13.

In some embodiments, a base plate 11 may comprise a base cutout 21. Generally, a base cutout 21 may comprise a cutout, opening, aperture, etc., formed in the base plate 11 which may be sized, shaped, and located to prevent the base plate 11 from blocking the camera(s) 201 and flash(es) 202 of an electronic device 200 that may be coupled to the base plate 11. Likewise, and in some embodiments, a receiver plate 31 may comprise a receiver cutout 38. Generally, a receiver cutout 38 may comprise a cutout, opening, aperture, etc., formed in the receiver plate 31 which may be sized, shaped, and located to prevent the receiver plate 31 from blocking the camera(s) 201 and flash(es) 202 of an electronic device 200 that may be coupled to the base plate 11. In preferred embodiments, a base cutout 21 and a receiver cutout 38 may be aligned when the receiver plate 31 is in the first position 71 to prevent both the base plate 11 and receiver plate 31 from blocking the camera(s) 201 and flash(es) 202 of an electronic device 200 that may be coupled to the base plate 11.

Any suitable coupling method, device, or fastener may be used to couple an object, such as an electronic device 200, to a base plate 11. In preferred embodiments, the device 100 may comprise an adhesive fastener 22 which may be configured to adhere to both the base plate 11 and electronic device 200. For example, an adhesive fastener 22 may comprise acrylic double sided tape, double sided polyethylene foam tape, or any other suitable double sided adhesive fastener which may be suitable for coupling an electronic device 200 to the front surface 13 of the base plate 11.

In some embodiments, the device 100 may comprise grip texturing 39 which may be disposed on a receiver plate 31, first receiver wall 33, second receiver wall 35, base plate 11, and/or on any other element or surface of the device 100. Generally, grip texturing 39 may comprise one or more ridges, bumps, stippling, or other friction enhancing surface feature which may enhance a user's ability to grip a portion of the device 100 or to manipulate the device 100 into and between the first 71 and second 72 positions. In preferred embodiments the device 100 may comprise grip texturing 39 which may be disposed on the second receiver wall 35 proximate to a retainer lip 37 and retainer 14.

In some embodiments, the plate interior surface 32, first wall interior surface 34, second wall interior surface 36, and/or the rear surface 12 may comprise or may be made from a non-marring material which may be configured to contact portions of an object that is placed within the cavity 51. For example, the plate interior surface 32, first wall interior surface 34, second wall interior surface 36, and/or the rear surface 12 may comprise or may be made from a non-marring material which may be configured to contact portions of an article of eyewear or glasses that is placed within the cavity 51 without scratching, abrading, or otherwise marring the lenses and other portions of the article of eyewear or glasses. In preferred embodiments, a non-marring material may comprise felt which may be a textile material that is produced by matting, condensing and pressing fibers together. In further embodiments, a non-marring material may comprise natural and/or synthetic rubber material, such as latex rubber, silicone foam, silicone rubber, etc., natural and/or synthetic foam material, such as rubber foam, urethane foam, plastic foam, neoprene foam, latex foam rubber, polyurethane foam rubber, etc., synthetic fabrics, such as polyester, acrylic, nylon, rayon, acetate, spandex, spandex blends, etc., natural fabrics, such as coir, cotton, hemp, jute, canvas, flax, leather, linen, ramie, wool, silk, or any other suitable flexible natural or synthetic material including combinations of materials which may be suitable for contacting glass and plastic eyewear lenses in a non-marring manner.

While some exemplary shapes and sizes have been provided for elements of the device 100, it should be understood to one of ordinary skill in the art that the base plate 11, receiver plate 31, receiver walls 33, 35, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the device 100 may be made from or may comprise durable materials such as aluminum, steel, other metals and metal alloys, wood, hard rubbers, hard plastics, fiber reinforced plastics, carbon fiber, fiberglass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. An eyewear storage device, the device comprising:
a base plate having a rear surface and an opposing front surface;
a receiver plate having a plate interior surface;
a first receiver wall coupled to the receiver plate, the first receiver wall having a first wall interior surface;
a second receiver wall coupled to the receiver plate, the second receiver wall having a second wall interior surface, wherein the first wall interior surface and the second wall interior surface extend away from the plate interior surface so that the first wall interior surface and the second wall interior surface face each other, and wherein the first receiver wall is movably coupled to the base plate so that the receiver plate is movable between a first position and a second position; and
a cavity formed between the rear surface, plate interior surface, first wall interior surface, and second wall interior surface when the receiver plate is in the first position.

2. The device of claim 1, wherein the first receiver wall is movably coupled to the base plate via a hinge.

3. The device of claim 1, wherein the second receiver wall is removably coupled to the base plate.

4. The device of claim 3, further comprising a retainer lip and a retainer, and wherein the second receiver wall is removably coupled to the base plate via removably engaging the retainer to the retainer lip.

5. The device of claim 1, further comprising a bottom plate that is coupled to the base plate.

6. The device of claim 5, further comprising a support arm that is coupled to the base plate, and wherein the support arm and bottom plate are configured to rest on a supporting surface to support the device in an upright position.

7. The device of claim 6, further comprising a support tab that is movably coupled to the bottom plate.

8. The device of claim 1, wherein the base plate comprises a base cutout and the receiver plate comprises a receiver cutout.

9. The device of claim 8, wherein the base cutout and receiver cutout are aligned when the receiver plate is in the first position.

10. The device of claim 1, further comprising an adhesive fastener which is configured to couple an electronic device to the front surface.

11. The device of claim 1, wherein the rear surface comprises a non-marring material.

12. An eyewear storage device, the device comprising:
a base plate having a rear surface and an opposing front surface;
a receiver plate having a plate interior surface;
a first receiver wall coupled to the receiver plate, the first receiver wall having a first wall interior surface;
a second receiver wall coupled to the receiver plate, the second receiver wall having a second wall interior surface, wherein the first wall interior surface and the second wall interior surface extend away from the plate interior surface so that the first wall interior surface and the second wall interior surface face each other, wherein the second receiver wall is removably coupled to the base plate, and wherein the first receiver wall is movably coupled to the base plate via a hinge so that the receiver plate is movable between a first position and a second position;
a first gripping assembly coupled to the base plate and extending above the front surface;
a second gripping assembly coupled to the base plate and extending above the front surface; and
a cavity formed between the rear surface, plate interior surface, first wall interior surface, and second wall interior surface when the receiver plate is in the first position.

13. The device of claim 12, further comprising a retainer lip and a retainer, and wherein the second receiver wall is removably coupled to the base plate via removably engaging the retainer to the retainer lip.

14. The device of claim 12, further comprising a bottom plate that is coupled to the base plate.

15. The device of claim 14, further comprising a support arm that is coupled to the base plate, and wherein the support arm and bottom plate are configured to rest on a supporting surface to support the device in an upright position.

16. The device of claim 15, further comprising a support tab that is movably coupled to the bottom plate.

17. The device of claim 12, wherein the base plate comprises a base cutout and the receiver plate comprises a receiver cutout.

18. The device of claim 17, wherein the base cutout and receiver cutout are aligned when the receiver plate is in the first position.

19. The device of claim 12, wherein the plate interior surface comprises a non-marring material.

20. The device of claim 12, wherein the rear surface comprises a non-marring material.
